(19) United States
(12) Patent Application Publication
(10) Pub. No.: US 2006/0160484 A1
(43) Pub. Date: Jul. 20, 2006

(54) Door with integrated identification system in the air curtain device

(76) Inventor: Robert Falk, Schwelm (DE)

Correspondence Address: JORDAN AND HAMBURG LLP, 122 EAST 42ND STREET, SUITE 4000, NEW YORK, NY, 10168, US

(21) Appl. No.: 10/564,687

(22) PCT Filed: Jul. 8, 2004
(86) PCT No.: PCT/EP04/07461

§ 371 Date: Mar. 13, 2006

(30) Foreign Application Priority Data
Jul. 11, 2003 (DE) 103 31 742.2

(51) Int. Cl. E06B 7/02

(52) U.S. Cl. 454/195

(57) ABSTRACT

The invention relates to a door device (10) with at least one door (11), for opening and closing a passageway (27), such as used in stores, public buildings, or similar. The doors (11) may be displaced in a door frame (12), for example, by means of a rotational or longitudinal displaceable mounting. The door device (10) is further provided with at least one air curtain device (30), essentially running along the complete height of the passageway (27) and which generates an exiting air curtain (33), such that, with the door (11) open, the passageway (27) is screened by the air curtain (33). The generated air curtain (33) serves to reduce the energy losses which occur when air from the outside (28) of the door device (10) reaches the inside (29) of the door device (10), or vice versa. According to the invention, a door device (10) may be achieved which not only permits the access of people and objects, but also identification of the people, objects, or similar and the management thereof is as uncomplicated as possible, whereby the door device (10) is provided with at least one additional identification system (40). Said identification system (40) comprises at least one sensor unit (41), a control unit (42) and an output unit (43) which are connected to each other. Furthermore, at least one sensor unit (41) in the identification system (40) is integrated in the air curtain device (30).

The invention relates to a door device comprising at least one door for opening and closing a passage according to the type defined in the preamble of claim 1. Very different embodiments of such door devices are widely known. They serve for closing the doorway of a passage of for example stores, shops, airports, public buildings and the like. The mentioned door device also contains a vertical air curtain device, which essentially extends over the entire height of the passage, and which generates an exiting air curtain such that the passage is covered by the air curtain when the door is open. This air curtain device serves for keeping the energy losses, which are generated by the opened door, as small as possible. The energy losses, which occur when the door is open, are caused by the different temperature and climate conditions outside and inside the door.

From the documents DE 102 24 527 A1, DE 102 24 528 A1 as well as from patent specification DE 100 18 868 C2 it is known to provide different door devices with the above mentioned air curtain devices. In the above mentioned documents, the special embodiment of the air curtain device is described in connection with the door device. These documents also relate to the functioning and effect of the air curtain devices. Since these door devices are usually automatic doors, which can automatically free the passage, also sensors are used which detect whether a person wants to go through the passage or is momentarily present therein. As soon as these sensors provide a corresponding signal, the passage will be freed by the automatic door device.

It is also known to install a theft protection in the passage of a door device, by means of which it can be detected that unpaid goods, the securing device of which has not been removed, are transported from the secured area into the unsecured area. Also time detection or personnel control systems are known in the passage of door devices, since the passage now as before represents an eye of a needle, through which all persons, items or the like get from one area into another area. However, it is a drawback of the last mentioned systems that they are only installed in the region of the door device, but are not dependent on a person or an item going through the door. Thus, persons can for example go through the door device without announcing themselves at a present time detection system. This problem over all arises due to the separation of the single systems from the associated door device.

It is thus the object of the invention to develop a door device of the type defined in the preamble of claim 1, which does not only allow the passage of items and persons but simultaneously provides an identification of the persons, items or the like. Herein, the handling shall be as simple and uncomplicated as possible, so that the identification is only obtained by traversing the passage of the door device. This aim is achieved according to the invention by means of the measures mentioned in the characterizing part of claim 1, which have the following special importance.

According to the invention, the door device is provided with at least one additional identification system. This identification system contains at least one sensor unit, one control unit and one output unit, wherein the single units are connected to each other. The units do not have to be respectively connected to each other, but a serial connection also serves the purpose. The connection itself does not necessarily be realized by means of an electric line, but can also be achieved with an infrared, radio link system or the like. Furthermore, it is provided according to the invention that at least one sensor unit of the identification system is integrated in the housing of the air curtain device. Herein, it does not matter whether the sensor unit is placed within the housing of the air curtain device or on the outer face of the housing. It is also of no importance whether the housing of the air curtain device is indeed provided with such a device or not. By means of such a door device it is now possible to identify all persons, items or other objects which get through the passage of the door. Hereby it is avoided that the hitherto known goods securing, time detection, stock control and personnel control systems are deliberately circumvented. Thus, a person can for example not deliberately make the time detection system continue to run, as soon as he has left the inner door region through the passage. Unlike external goods securing systems, which have been placed in the interior in front of the door device, goods cannot get from the internal area into the external area of the door without being detected. Furthermore, it is advantageous that the sensors, which are required for a theft protection, do no more form obstacles in form of additional shackles or pillars in front of the door device. This is important for the security of the persons in the internal area of the door device in case of a fire alarm or the like, on the one hand, and for the cleaning staffs who have to drive round the additional pillars and shackles with their sweeping machines, on the other hand. Building designers and architects no more have to take care that additional room is provided for the installation of a goods securing, time detection, stock control or personnel control system. This planning step can thus be completely omitted, since the above described systems are integrated in the door device. Besides, the management of the identification by means of the door device according to the invention is especially simplified. Thus, only such goods have to be provided with a theft protection, which will be automatically detected by the identification system of the door device. Also for a time detection system it is sufficient that the persons only carry an identity card along, which will then be recognized by the identification system when they go through the door device. Of course, such an identification card can also be used to allow or to refuse certain persons the access through the door device. The stock of goods can also be detected in the door area by means of a door device, in that the bar code on the goods will be detected by the identification system and thus all incoming and outgoing goods will be administrated by the identification system.

Preferable embodiments of the door device are described in claims 2 through 19.

In a special embodiment of the door device, the air curtain device with the integrated sensor unit is provided as door post of the door frame. In this embodiment, the air curtain device is thus not displaced with the door, if this one is opened or closed. Consequently, an extensive cabling of the air curtain device and the integrated sensor unit can be omitted. It is thus an especially stable and low-maintenance technical embodiment of the door device. It is neither required to use especially light materials, since the air curtain device is provided as door post, as already mentioned.

In another embodiment of the door device, the air curtain device with the integrated sensor unit is located on the displaceable door itself. In this embodiment, the efficiency of the air curtain device is especially high, since the air curtain develops a very high protection effect especially during opening and closing of the door and the energy losses can thus be further reduced. If the door is opened, the special position of the air curtain device on the door is of no importance since the air curtain is in any way so strong that it can cover the entire width of the passage. In so far, with opened door, the effect of the air curtain device is the same as in the previously described embodiment. But also the reliability of the identification system is increased with the here described exemplary embodiment.

In another variant, the door device is provided with a one-piece or multi-piece sliding door and the door frame at least holds one mobile door in a longitudinally displaceable manner. In this variant, the air curtain device with the integrated sensor unit can be located on the longitudinally displaceable door, whereby the above mentioned advantages are achieved. But the air curtain device should be especially light, so that the total mass of the door including the air curtain device is not too heavy.

In another variant, the door device is provided with a one-piece or multi-piece double-wing door and the door frame holds at least one mobile door in a rotational manner. Herein, the air curtain device with the integrated sensor unit is provided as door post of the door frame. As already mentioned, this embodiment is an especially stable and maintenance-free variant. A part of the sensor unit can also be directly integrated in the double-wing door.

An additional variant of the door device provides that this one is a revolving door, wherein the displaceable door is present as an at least two-wing insert, which can rotate in use around a central rotation axis, and the circular cylindrical door frame accommodates the insert in a rotational manner. This variant already assures by itself that a direct air exchange between the internal and the external area of the door can never occur, since the revolving door itself is always positioned in between. On the one side of the passage (on the left or the right side, depending on the sense of rotation of the revolving door), the air curtain device with the integrated sensor unit is provided as door post of the circular cylindrical door frame. On the other hand, on the other side (opposed side) of the passage, the sensor unit is positioned in the door post. Thus, the whole passage is detected by the identification system. This special arrangement of air curtain device/sensor unit/door post or sensor unit/door post can be provided both in the entry area and in the exit area of the revolving door. Consequently, it is impossible for persons, goods or the like to get from the external area into the internal area or vice versa without being detected by the identification system.

In the hitherto described embodiments, the door (independent from the embodiment thereof) can be automatically displaceable by means of an additional drive unit, such that it automatically opens and closes the passage. Hereby, more energy costs can be saved on the one hand, since the door only has to be open when persons or goods really want to traverse the passage, and the passage through the door device is facilitated on the other hand, since for example an adult with a pram or a handicapped person does not have to open the door in a troublesome way by his own muscular strength. It goes without saying that in case of a sliding door, the drive unit displaces the door in a longitudinal sliding direction. In the case of a double-wing door, the drive unit automatically rotates the door, in the same way as the drive unit rotates the insert of a revolving door.

In another variant of the door device, the drive unit of the automatic door can be controlled by the output unit of the identification system, whereby the door can be opened or closed depending on the respective application. This measure enables for example to stop the automatically driven insert of a revolving door and to block the passage as soon as goods, which are still provided with a theft protection, have been detected by the identification system. In the same way it is possible that the passage remains blocked for persons, who have been recognized by the identification system, but for whom it is not allowed to free the passage through the door device.

The sensor unit of the identification system can contain a plurality of sensors, which are installed in intervals over the height of the passage in the air curtain device. This measure for example assures that children who play in the passage area of the door device can be recognized by the sensor unit, such that the door will not be closed by mistake. In hitherto common systems, usually an infrared sensor is placed in the upper portion of the passage, which is very often not able to detect children and animals, because their distance from the sensor is too large. Hereby, common systems present a high danger of accident.

It is also imaginable that this sensor unit is equipped with at least one antenna-like sensor, which essentially extends over the entire height of the passage in the air curtain device. Such a sensor is usually used in a goods securing system, since it can detect the goods provided with a theft protection according to the radio frequency principle. The signal, which is transmitted by the antenna-like sensor, is then received and exploited by the control unit, whereby different functions can be triggered, such as for example an alarm signal, closing of the door, triggering of a video camera, radio signal to the guards or the like.

In another variant of the door device it is also provided that the sensor unit contains different sensors which detect different measurable variables and transmit the signals, which result from this, to the control unit for evaluation and processing. Due to this measure, the application field of the door device is clearly extended, since the identification system cannot only be used to open and close the automatic door as soon as persons or goods want to traverse the passage, but simultaneously the traversing persons and goods can also be identified. Thus it is for example imaginable that goods, which are provided with a bar code, can be recognized by so called laser diodes, which are used as sensors in this case. A person, who goes through the passage and who has an identification card, can also be recognized by the identification system. It is already imaginable today that a person can be recognized by video sensors (i.e. small video cameras) on the base of the person's outer appearance and the delivered video signal by means of a corresponding evaluation algorithm in the control unit.

In a special variant of the door device, the identification system is a goods securing system, in which secured goods in the passage area of the door are recognized by the sensor unit and a signal is transmitted to the control unit, which evaluates this signal and sends a corresponding alarm signal to the output unit. For this purpose, the goods are provided with a theft protection, which is removed if the item is purchased. If however for any reason, items which are still provided with the theft protection get into the passage area of the door, the goods provided with the theft protection are recognized by the sensor unit. This one transmits a corresponding signal to the control unit, which thereupon initiates corresponding actions of the output unit, such as alarm signals, closing of the door, calling the guards or similar.

In a special variant, the identification system can also be a stock control system, in which the incoming and outgoing goods are recognized by the sensor unit in the passage area of the door and the generated signals are transmitted to the control unit, which exploits and processes these signals. The goods are provided with for example a bar code, such that the sensor unit can clearly recognize the goods. For very special goods, which have different outer forms, it is also imaginable that they can be recognized by video sensors on the base of their outer form.

In another variant of the door device, the identification system is present as time detection unit, in which the time of incoming and outgoing persons in the passage area of the door is detected by the sensor unit with respect to each single person and the generated signals are transmitted to the control unit, which exploits and processes these signals. For this purpose, the incoming or outgoing person has to carry along e.g. a special identification card, which is clearly recognized by the sensor unit. Hereby it can be assured that the abuse of the time detection system is made sensibly difficult.

In a variant of the door device, the identification system can also be a person control system, which identifies incoming and outgoing persons in the passage area of the door by means of the sensor unit and the generated signals are transmitted to the control unit, which exploits and processes these signals. Thus, the access to the passage of the door device can be allowed to special persons and refused to others. For this, the persons can also be provided with an identification card, which is clearly identified by the sensor unit.

It is to be noted here that also a combination of the above mentioned goods securing, stock control, time detection and personnel control systems is possible.

In another embodiment of the door device, the identification system also contains an input unit, which is connected to the control unit, whereby an additional safety or identification code can be transmitted to the control unit, in addition to the received signals of the sensor unit. Thus, it can be for example necessary that a person does not only have to carry along an identification card, in order to be identified by the sensor unit, but additionally has to input a numerical code into the input unit so that the passage is freed by the control unit.

It is also imaginable with the described door devices that the control unit of the identification system is linked to the air curtain device via a data transmission system and is hereby able to send and receive data, whereby also active elements, in particular the fan, the heating and the nozzle of the air curtain device can be triggered. Thus, it is possible to also transmit the data acquired by the air curtain device to the control unit of the identification system, which then manages the entire control of the door device. Thus, the air curtain device does not have to be provided with its own control unit, but it is sufficient that the data acquired by the air curtain device are transmitted to the control unit of the identification system for further processing. Hereby, a simple technical structure can be realized, in that another control device can be omitted.

It is also imaginable that the identification system also acquires climatic data from the area around the door by means of other sensors and transmits them to the control unit, whereby the active elements of the air curtain device, which is itself connected to the control unit, can be directly triggered. Thus, the identification system also assumes the function to acquire all climatic data from the area around the door and to use them for triggering the air curtain device.

In a special variant of the door device, the control unit of the identification system is linked to an external central computer via a data transmission system, such that hereby data can be exchanged between the control unit of the identification system and the external central computer. Thus, for example in case of a fire alarm, the door of the door device can be automatically opened or closed. It is also possible to supervise and, if necessary, to influence all the functions of the door device, i.e. also the ones of the identification system and the air curtain device, by a central unit.

In the following, the invention will be explained in detail by means of the annexed drawing.

In the drawing:

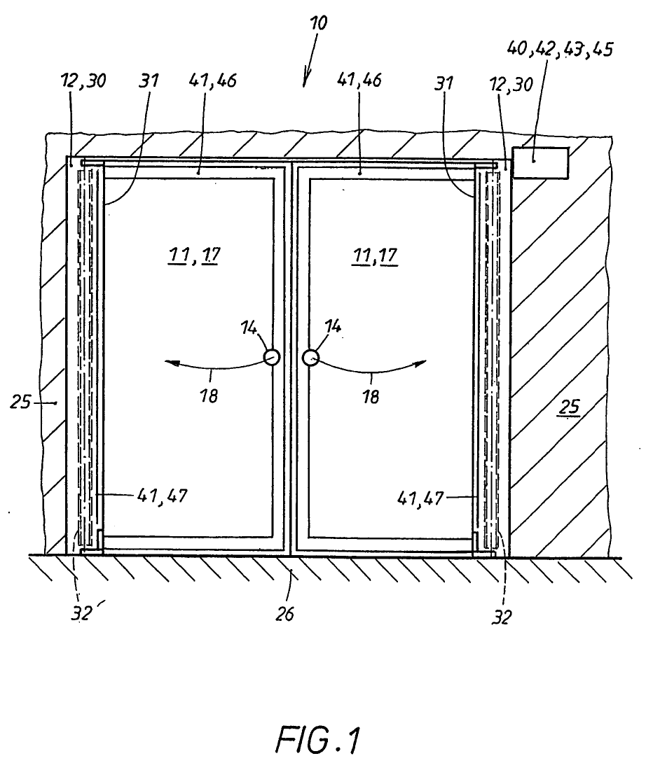

FIG. 1 is a front view of a door device in form of a double-wing door,

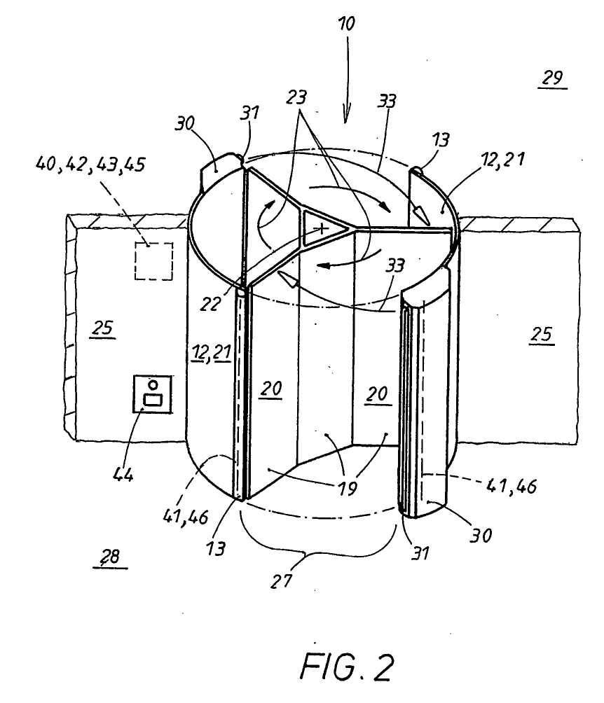

FIG. 2 is a perspective view of a door device in form of a revolving door,

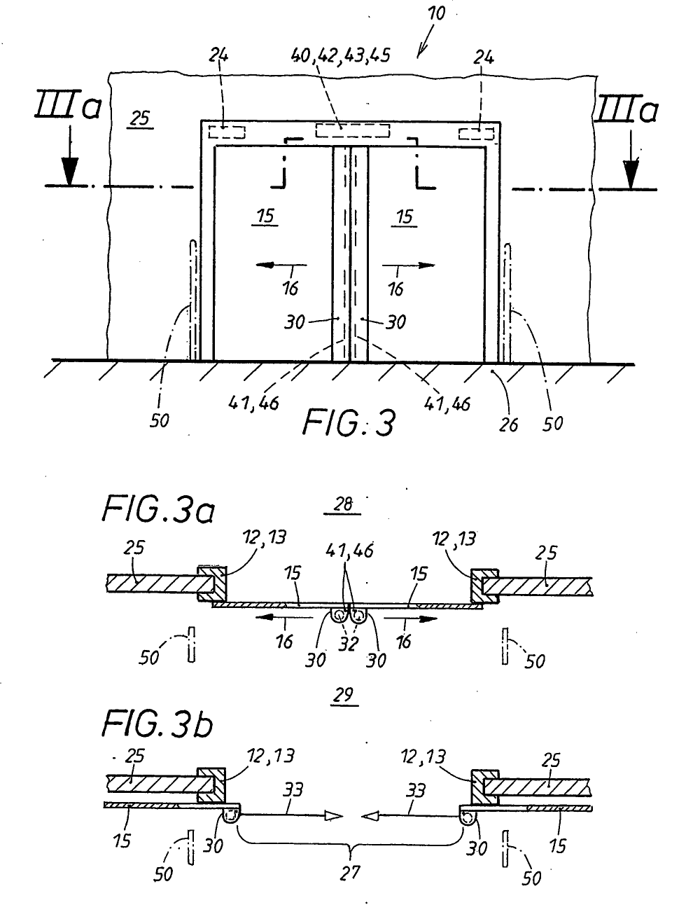

FIG. 3 is a front view of a door device in form of a sliding door,

FIG. 3a is a sectional view of the sliding door of FIG. 3 with closed door and

FIG. 3b is the same section through the sliding door of FIG. 3, but with opened door.

Door device 10 contains at least one door 11, which is provided for opening and closing a passage 27. Door device 10 further contains a door frame 12, in which door 11 is held in a displaceable manner in order to open or close passage 27. Furthermore, door device 10 comprises at least one vertical air curtain device 30, which essentially extends over the entire height of passage 27 and which generates an exiting air curtain 33, such that passage 27 is covered by air curtain 33 when door 11 is open. Such a door device 10 is represented in FIGS. 1 through 3. The special characteristic of door device 10 is that it is provided with at least one additional identification system 40, wherein this identification system contains at least one sensor unit 41, one control unit 42 and one output unit 43, which are connected to each other. At least one sensor unit 41 of identification system 40 is integrated in the vertical air curtain device 30. This measure enables to realize a control of persons, goods or the like in passage 27 of door device 10. Passage 27 now as before represents an eye of a needle, through which all persons and goods get from the external area 28 into the internal area 29 of door device 10. Thus, the site of passage 27 is highly appropriate to realize a corresponding control here. In FIGS. 3, 3a and 3b a goods securing system 50 of the common type is indicated. As it is clearly visible in FIGS. 3a and 3b, it is possible that persons or goods can get through passage 27 behind goods securing system 50 (i.e. between system 50 and wall 25). This drawback is in any case avoided by the special location of sensor unit 41 of identification system 40 in said air curtain device 30.

There is neither an additional identification system in the door area of door device 10. Thus it is possible for the cleaning staff to also keep the door area clean by means of cleaning machines. The architects neither have to consider an additional identification system and the space requirement thereof during the planning of the door area.

In FIG. 1 door device 10 is a double-wing door 17. Double-wing doors 17 are special doors 11 of door device 10. These double-wing doors 17 can be pivoted to the sides (in the direction of arrows 18) by means of handles 14, as far as no additional drive unit 24 is present, which automatically opens and closes double-wing door 17. In this door device 10, said air curtain device 30 with the integrated sensor unit 41 is provided as door post 13 on the left and right side of door frame 2. Air curtain device 30 is thus arranged in a stationary manner, since it is a fixed component of door device 10. A part of sensor unit 41, 46 can also be present in said double-wing doors 17.

If one wing 17 is now opened, the air curtain device will cover passage 27 by means of air curtain 33 exiting from air outlet 31. Air curtain 33 is generated by fan 32. Sensor unit 41 is for example provided as antenna-like sensor 47 between said fan 32 and said air outlet 31. This sensor 47 extends over the entire height of passage 27. Thus, the entire passage 27 is supervised by said antenna-like sensor 47. Consequently, neither a person nor an object can get from the external area 28 into the internal area 29 or vice versa without being detected by said identification system 40. Identification system 40 and substantial components thereof, namely control unit 42, output unit 43 and fan 45 are represented as black box in wall 25 in FIG. 1. Sensor unit 41, which is in this case composed of the two antenna-like sensors 47 on the left and right side, is of course also connected to the rest of identification system 40. However, the way, in which this is realized, is not relevant for the invention.

FIG. 2 discloses a door device 10 which is a revolving door 19, wherein in this case the displaceable door 11 is provided as double-wing insert 19, which in use rotates around a central rotation axis 22 and the circular cylindrical door frame 21 accommodates said insert 19 in a rotational manner. Revolving door 19 rotates clockwise around the central axis of rotation 22 according to the indicated arrows 23. The exiting air curtain 33 also leaves said air curtain device clockwise through air outlet 31. Of course, the sense of rotation 23 of insert 19 can also be anticlockwise, but air curtain 33 also has to be reversed then, i.e. said air curtain device 30 has to be consequently provided at the other door post 13. Air curtain device 30 as well as door post 13 respectively accommodates sensors 46 of sensor unit 41. These sensors are thus placed on the left side and on the right side of passage 27, such that also with revolving door 19, each person or object has to go through the detection area of sensors 46 if he wants to traverse door device 10. In this embodiment, also an additional input unit 44 is provided, by means of which an additional security or identification code can be transmitted to control unit 42. This security or identification code can then be evaluated by control unit 42—together with the other signals of sensor unit 41. Depending on the application case, the access through door device 10 will then be allowed or refused. Input unit 44 itself can comprise a keyboard, a magnetic card reader, a video camera, a finger-print sensor or similar. FIG. 2 does not represent how said input unit 44 and said sensor unit 41, which contain sensors 46, are connected to identification system 40.

FIG. 3a shows another embodiment of door device 10, which comprises a sliding door 15. The sliding doors 15 are in this exemplary embodiment respectively provided with an air curtain device 30 on the passage side thereof. In the closed condition of doors 15, air curtain devices 30 are thus adjacent in parallel to each other. Consequently, also both sensor units 41 of identification system 40 are nearly adjacent to each other. If now persons approach door device 10, doors 15 can be displaced in longitudinal direction, i.e. in the direction of arrows 16, by means of drive unit 24. Hereby, passage 27 is freed by means of door device 10. It is also visible here that each person or object has to go though the opened passage 27 and thus through the area of sensor unit 41 in order to get from external area 28 into an internal area 29. In this case, identification system 40 with control unit 42 and output unit 43 is arranged in the upper part of door frame 12. In FIG. 3 also the common goods securing systems 50 are represented.

In FIG. 3a it is clearly visible that the common goods securing systems 50 are placed at a clear distance from wall 25, such that persons or objects can slip through the intermediate zone between goods securing system 50 and wall 25 in a tricky way in order to be not detected by goods securing system 50. This is not possible with the integrated identification system. The complete door device 10 is mounted on wall 25 by doors posts 13 in U-form. In the upper portion of door frame 12 there is enough space for accommodating drive unit 24 and the essential components of identification system 40.

In FIG. 3b sliding doors 15 free passage 27 through door device 10. In this case, air curtain devices 30 generate the horizontal air curtains 33, such that the entire passage area 27 is efficiently protected.

It is also clearly visible in FIGS. 3a and 3b how sensor unit 41 is respectively placed in air curtain device 30 or in the housing. It has to be noted once again that sensor unit 41 can be composed of different sensors 46 and antenna-like sensors 47. Thus, the desired measuring data can be acquired and transmitted from sensor unit 41 to control unit 42 for further processing. Since control unit 42 can itself consist of an intelligent circuit, a programmed microprocessor or similar, diverse applications are imaginable. Thus, control unit 42 of identification system 40 can be for example linked to an external central computer via a data transmission system. Just newer buildings have a so called distributing centre, which is controlled by a central computer. The central computer can thus serve to open or close door device 10, for example in case of a fire alarm or a burglar alarm. Hereby, also air curtain device 30 with the active elements thereof can be triggered.

It is to be noted that the here represented embodiments of door device 10 are only exemplary realizations of the invention. However, they are not limited to the represented combinations. It goes without saying that the represented components and elements of the invention can also exist in other embodiments and constructions which show similar characteristics as those which have been described here.

### LIST OF REFERENCE NUMERALS

10 door device
11 door
12 door frame
13 door post
14 door handle
15 sliding door, special door 11
16 arrow of the sliding direction of
17 double-wing door, special door 11
18 arrow of the pivoting direction of
19 revolving door, special door 11
20 door wing
21 circular cylindrical door frame, special door frame 12
22 central axis of rotation/point of rotation
23 arrow of the sense of rotation of
24 drive unit
25 wall
26 floor
27 passage
28 external area
29 internal area
30 air curtain device
31 air outlet
32 fan
33 air curtain
40 identification system
41 sensor unit
42 control unit
43 output unit
44 input unit
45 housing
46 sensor
47 antenna-like sensor
50 sensors of a goods securing system of the state of the art

1-19. (canceled)

20. A door device comprising:
a door for opening and closing a passage;
a door frame in which said door is movably disposed;
a vertical air curtain device extending over a height of the passage, said air curtain device generating an exiting air curtain and disposing said air curtain against the passage when said door is open;
said door device further comprising an identification system;
said identification system further comprising a sensor, a control unit and an output unit, each being interconnected; and
said sensor being integrated in said air curtain device or a housing of said air curtain device.

21. The door device of claim 20, wherein said air curtain device is a door post of said door frame.

22. The door device of claim 20, wherein said air curtain device is disposed on said door.

23. The door device of claim 20, wherein said door is a one-piece or a multi-piece sliding door and said door is longitudinally movable against said door frame.

24. The door device of claim 20, wherein:
said door device is a one-piece or a multi-piece double-wing door;
said door is rotationally movable against said door frame; and
a part of said sensor is disposed in said door.

25. The door device of claim 20, wherein:
said door is a revolving door;
said door including a two-wing insert which rotates about a central rotation axis; and
said door frame being a circular cylindrical door frame which rotationally secures said insert.

26. The door device of claim 20, further comprising a drive unit, said door being automatically opened and closed by said drive unit.

27. The door device of claim 26, wherein said drive unit is controlled by said output unit for opening and closing said door.

28. The door device of claim 20, wherein the sensor is a plurality of sensors disposed at predetermined intervals over the height of said passage in said air curtain device.

29. The door device of claim 20, wherein said sensor further comprises an antenna sensor extending over the height of the passage in said air curtain device.

30. The door device of claim 20, wherein said sensor is a plurality of sensors, each of said plurality of sensors respectively sensing different predetermined variables and transmitting sensed signals to said control unit.

31. The door device of claim 20, wherein:
said identification system is a goods securing system;
said sensor sensing secured goods in the passage area of said door and transmitting sensed signals to said control unit; and
said control unit processing said signals and transmitting a corresponding alarm signal to said output unit.

32. The door device of claim 20, wherein:
said identification system is a stock control system; and
said sensor sensing incoming and outgoing goods in the passage area of said door, generating signals and transmitting said sensed signals to said control unit.

33. The door device of claim 20, wherein:
said identification system is a time detection system;
said sensor sensing a time of incoming and outgoing of each person in the passage area of said door, generating signals and transmitting said sensed signals to said control unit.

34. The door device of claim 20, wherein:
said identification system is a person control system;
said sensor identifying incoming and outgoing persons in the passage area of said door, generating signals and transmitting said sensed signals to said control unit.

35. The door device of claim 20, wherein:
said identification system further comprises an input unit connected to said control unit for receiving a safety code and/or identification code; and
said code being transmitted to said control unit with the received signals of said sensor.

36. The door device of claim 20, wherein:
said air curtain device further comprises active elements including one or more of a fan and a heating system and a nozzle;
said door device further comprising a data transmission system for sending and receiving data;
said control unit communicating with said air curtain device via said data transmission system for controlling said active elements.

37. The door device of claim 36, wherein:
said sensors sense climatic data from a predetermined area around said door and transmit said sensed data to said control unit for controlling said active elements.

38. The door device of claim 20, further comprising:
a data transmission system for sending and receiving data:
said control unit communicating with an externally disposed computer via said data transmission system.
